(19) United States
(12) Patent Application Publication
(10) Pub. No.: US 2019/0136712 A1
(43) Pub. Date: May 9, 2019

(54) Multilayer Encapsulated Heat Shield for a Turbocharger

(71) Applicant: BorgWarner Inc., Aubum Hills, MI (US)

(72) Inventor: Rajmohan T. Chandramohanan, Fletcher, NC (US)

(73) Assignee: BorgWarner Inc., Auburn Hills, MI (US)

(21) Appl. No.: 15/803,296

(22) Filed: Nov. 3, 2017

(51) Int. Cl. F01D 25/08

(52) U.S. Cl. CPC F01D 25/08; F02B 37/00

(57) ABSTRACT

A turbocharger (10) including a bearing housing (20), a shaft (40) mounted for rotation in the bearing housing (20), and a turbine wheel (34) attached to one end of the shaft (40) and configured to be driven by exhaust gas flow is disclosed. A heat shied (12) is also disclosed, the heat shield (12) being designed for positioning between the bearing housing (20) and the turbine wheel (34) of the turbocharger (10). The heat shield (12) may include a closed end wall (48) and a sidewall (46) extending from the closed end wall (48). The heat shield (12) may further include a center opening (54) in the closed end wall (48) that is configured to receive the shaft (40) of the turbocharger (10). Additionally, the heat shield (12) may include an outer layer (72) and an inner layer (76), and an insulation material (74) disposed between the outer layer (72) and the inner layer (76) of the heat shield (12), the outer layer (72) and the inner layer (76) encapsulating the insulation material (74).

### TECHNICAL FIELD

This disclosure generally relates to an exhaust gas turbocharger for an internal combustion engine. More particularly, this disclosure relates to a multilayer encapsulated heat shield disposed between the bearing housing and the turbine wheel of a turbocharger.

### BACKGROUND

A turbocharger is a type of forced induction system that may be used with internal combustion engines of trucks, cars, trains, aircraft and construction equipment, for example. Turbochargers deliver compressed air to an engine intake, allowing more fuel to be combusted, thus boosting the horsepower of the engine without significantly increasing the engine weight. In turn, turbochargers allow the use of smaller engines that are capable of producing the same amount of horsepower as larger, normally aspirated engines. Using a smaller engine in a vehicle has the desired effect of decreasing the mass of the vehicle, increasing performance and enhancing fuel economy. Moreover, the use of turbochargers permits more complete combustion of the fuel delivered to the engine, which contributes to the highly desirable goal of a cleaner environment.

Turbochargers typically include a turbine housing connected to the exhaust manifold of the engine, a compressor housing connected to the intake manifold of the engine, and a center bearing housing disposed between and coupling the turbine and compressor housings together. A turbine wheel in the turbine housing is rotatably driven by an inflow of exhaust gas supplied from the exhaust manifold. A shaft, typically supported by bearings for rotation in the center bearing housing, connects the turbine wheel to a compressor impeller in the compressor housing so that rotation of the turbine wheel causes rotation of the compressor impeller. The bearings are often free-floating bearings; and crankcase lubricant under pressure is pumped through the free-floating bearings to lubricate the rotating bearing interfaces. The shaft connecting the turbine wheel and the compressor impeller defines a line, which is the axis of rotation. As the compressor impeller rotates, it increases the air mass flow rate, airflow density and air pressure delivered to the cylinders of the engine via the engine intake manifold.

In a turbocharger, the exhaust gas spins the turbine wheel at speeds that may approach hundreds of thousands of revolutions per minute thereby contributing to the temperature increase within the already high temperature exhaust gas environment of the turbine housing. For example, temperatures of up to 850° C. occur in the exhaust gas turbine of diesel engines, and of up to 1,050° C. in the case of Otto cycle engines. Turbochargers therefore must be designed to combat two significant problems: first, the high temperature of the turbine must not be allowed to adversely affect the lubricating oil in the bearing housing or otherwise damage other components of the turbocharger; and second, oil should not be allowed to escape from the bearing housing into the turbine or compressor housing, and thereafter into the environment. These problems may be partially addressed by conventional heat shields placed between the turbine wheel and the bearing housing in order to reduce the heat transferred into the bearing housing from the turbine housing.

Such heat shields provide a degree of thermal protection for various components of the turbocharger, including, for example, the lubrication system and the piston rings oftentimes associated with the shaft of the turbocharger in order to seal the oil in the bearing housing off from the turbine housing. While conventional heat shields have contributed to the improved efficiency of turbochargers, damage associated with the high heat environment during operation and during a heat soak period after the hot shut down of an engine may nevertheless occur. Such damage may include burning of the oil in the bearing housing. In turn, sludge, coked oil or other burned oil deposits may accumulate on the bearings and on bearing housing surfaces. Due to the abrasive nature of such deposits and the fact that their buildup reduces clearances, these deposits may be detrimental to optimal turbocharger performance and should therefore be avoided. Because a turbocharger and its various components are expected to have a lifespan that matches that of the engine with which it operates, the design of turbochargers and turbocharger components must evolve to meet the current challenges and the harsh, increasingly demanding operating conditions of internal combustion engines.

### SUMMARY

In accordance with one aspect of the present disclosure, a heat shield configured to be disposed between a bearing housing and a turbine wheel of a turbocharger is disclosed. The disclosed heat shield may include a closed end wall and a sidewall extending from the closed end wall, and a center opening in the closed end wall, the center opening configured to receive a shaft of the turbocharger. The heat shield may further include an outer layer and an inner layer. In addition, the disclosed heat shield may include an insulation material disposed between the outer layer and the inner layer of the heat shield, the outer layer and the inner layer encapsulating the insulation material.

In accordance with another aspect of the present disclosure, a turbocharger is disclosed which may include a bearing housing and a shaft mounted for rotation in the bearing housing. The disclosed turbocharger may also include a turbine wheel attached to one end of the shaft and configured to be driven by exhaust gas flow. The turbocharger may further include a heat shield disposed between the bearing housing and the turbine wheel. The heat shield of the disclosed turbocharger may include a closed end wall and a sidewall extending from the closed end wall, and a center opening in the closed end wall, the center opening configured to receive a shaft of the turbocharger. In addition, the heat shield may include an outer layer and an inner layer, and an insulation material disposed between the outer layer and the inner layer, the outer layer and the inner layer encapsulating the insulation material.

In accordance with yet another aspect of the present disclosure, a turbocharger is disclosed which may include a turbocharger housing having a compressor housing, a bearing housing and a turbine housing. The disclosed turbocharger may also include a turbine wheel located in the turbine housing, a compressor wheel located in the compressor housing, and a shaft extending through the bearing housing and connecting the turbine wheel and the compressor wheel. In addition, the disclosed turbocharger may include a multilayered heat shield disposed between the turbine wheel and the bearing housing. The heat shield of the disclosed turbocharger may include a first layer comprising stainless steel, a second layer comprising an insulation material, and a third layer comprising stainless steel, the first and the third layers being attached to encapsulate the second layer.

### BRIEF DESCRIPTION OF THE DRAWINGS

Advantages of the present disclosure will be readily appreciated as the disclosure becomes better understood with reference to the following detailed description when considered in conjunction with the accompanying drawings, wherein:

FIG. 1 is a cross-sectional view of a portion of a turbine section of an exhaust gas turbocharger, including an exemplary heat shield disposed between the bearing housing and the turbine wheel of the turbocharger.

FIG. 2 is a perspective view of the exemplary heat shield of FIG. 1, showing an outer surface of the heat shield.

FIG. 3 is a perspective view of the exemplary heat shield of FIG. 1, showing an inner surface of the heat shield.

FIG. 4 is an enlarged cross-sectional view of the exemplary heat shield illustrated in FIG. 1.

FIG. 5 is a plan view of an exemplary heat shield according to this disclosure.

FIG. 6 is a partial cross-sectional view along line 6-6 of the exemplary heat shield of FIG. 5.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

Referring to the drawings generally, an exemplary heat shield for use in a turbocharger of an internal combustion engine is depicted. The disclosed heat shield may be employed in turbochargers of internal combustion engines used to power trucks, cars, trains, aircraft and construction equipment, for example. In addition, the heat shield disclosed herein may be employed in turbochargers of diesel cycle or Otto cycle internal combustion engines.

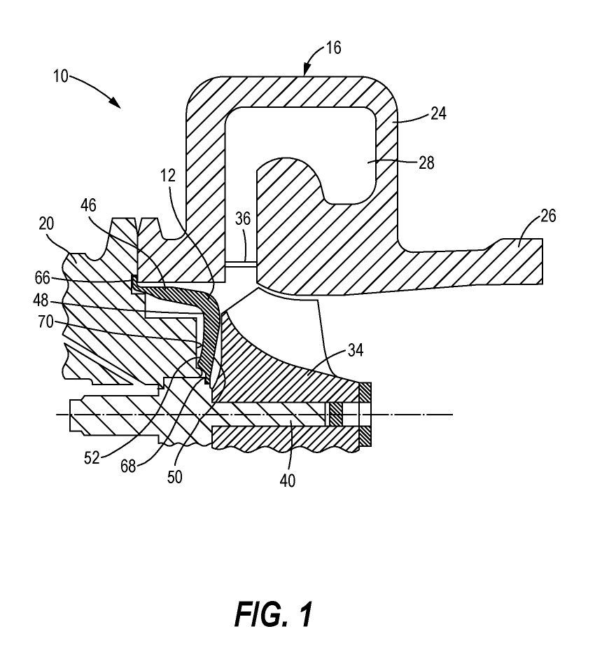

Referring specifically to FIG. 1, an exhaust gas turbocharger 10 is shown that incorporates a heat shield 12 of this disclosure. The turbocharger 10 includes a turbine section 16, a compressor section (not shown) and a center bearing housing 20 disposed between and connecting the compressor section to the turbine section 16. The turbine section 16 includes a turbine housing 24 that defines an exhaust gas inlet (not shown), an exhaust gas outlet 26, and a turbine volute 28 disposed in the fluid path between the exhaust gas inlet and exhaust gas outlet 26. A turbine wheel 34 is disposed in the turbine housing 24 between the turbine volute 28 and the exhaust gas outlet 26. Variable guide vanes 36 may be positioned in the volute 28 adjacent the turbine wheel 34 to control gas flow to the turbine wheel 34. A shaft 40 connected to the turbine wheel 34 is radially supported for rotation within in the bearing housing 20 and extends into the compressor section. The compressor is not depicted herein as it is not necessary for understanding the present disclosure; however, a typical compressor section includes a compressor housing that defines an air inlet, an air outlet and a compressor volute. A compressor wheel is typically disposed in the compressor housing between the air inlet and the compressor volute and is connected to the shaft 40. The shaft may include annular grooves (not shown) in its outer circumference proximate the turbine wheel, which may contain piston ring-type seal rings. Such rings may be incorporated to provide a seal between the bearing housing 20 and the turbine housing 24, thereby preventing any potential leakage of lubricating oil from within the bearing housing 20 into the turbine housing 24.

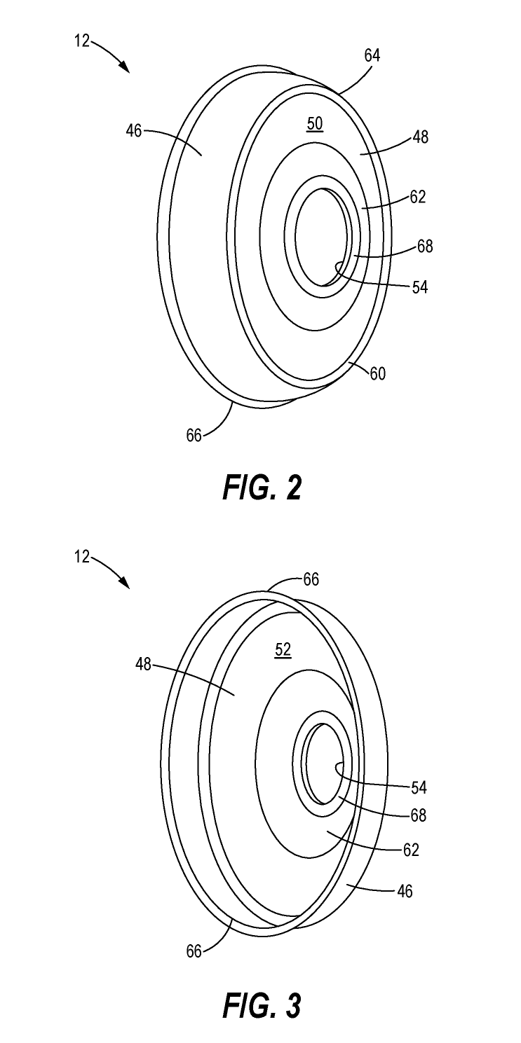

The heat shield 12, described in detail below, is provided in the turbine section 16 between the turbine wheel 34 and the bearing housing 20 to reduce heat transfer from the turbine section 16 to the bearing housing 20 thereby increasing the efficiency and durability of the turbocharger 10. With further reference to FIGS. 2 and 3, the heat shield 12 may have a construction and shape that provides improved turbocharger efficiency relative to other turbochargers having conventional heat shields. The disclosed heat shield 12 is a generally cup-shaped member having a cylindrical sidewall 46 and a closed end wall 48. The disclosed heat shield 12 is not, however, limited to the depicted cup-shaped configuration, and may instead be of any other desirable shape such as a disk shape. The heat shield 12 includes an outer surface 50 and an inner surface 52, and the closed end wall 48 has a center opening 54 formed therethrough. The outer and inner surfaces 50, 52 of the heat shield 12 may include a steel alloy such as stainless steel, as described more specifically below.

The closed end wall 48 may include a shoulder 60 formed about a periphery thereof, and an angled portion 62 that connects the shoulder 60 and closed end wall 48 to the center opening 54. While the shoulder 60 and angled portion 62 are depicted in FIGS. 2 and 3 as having delineated edges, these elements may instead be relatively indistinguishable, gradual contour changes in the sidewall 46, at an edge 64, or in the closed end wall 48 of the heat shield 12, or may be eliminated entirely, depending on the desired dimensions/shape of the heat shield 12 and the turbocharger 10. The edge 64 connects the sidewall 46 to the closed end wall 48. This edge 64 may be contoured in a manner that allows exhaust gas to be specifically directed onto the turbine wheel 34. For example, the edge 64 of the heat shield 12 may be sharp, angled or curved in a concave or a convex configuration depending on the particular turbocharger. The opposite end of the sidewall 46 may include a retaining tab 66 that extends generally perpendicularly outward therefrom. For example, the tab 66 may be generally parallel to the closed end wall 48 and/or the shoulder 60. While the retaining tab 66 is depicted herein as being continuous around the sidewall 46, the retaining tab 66 may instead be a series of individual tabs extending outwardly from the sidewall 46. As depicted in FIG. 1, the retaining tab 66 may be relatively flat and may have a reduced thickness in comparison to the sidewall 46 and the closed end wall 48. Similarly, the center opening 54 of the heat shield 12 may be defined by a center edge 68 that may also be relatively flat and have a reduced thickness in comparison to the sidewall 46 and the closed end wall 48.

Referring again to FIGS. 1, 2 and 3, the heat shield 12 is disposed in the turbocharger 10 such that the retaining tab 66 may be clamped or otherwise secured between the turbine housing 24 and the bearing housing 20, thereby securing the heat shield 12 in place. The shaft 40 of the turbocharger 10 extends through the center edge 68 of the heat shield center opening 54; and the closed end wall 48 of the heat shield 12 is disposed in a space between the turbine wheel 34 and turbine-facing surface 70 of the bearing housing 20. Importantly, the outer surface 50 of the heat shield 12 is spaced at a slight but sufficient distance from the turbine wheel 34 so as not to interfere with the rotation of the turbine wheel 34.

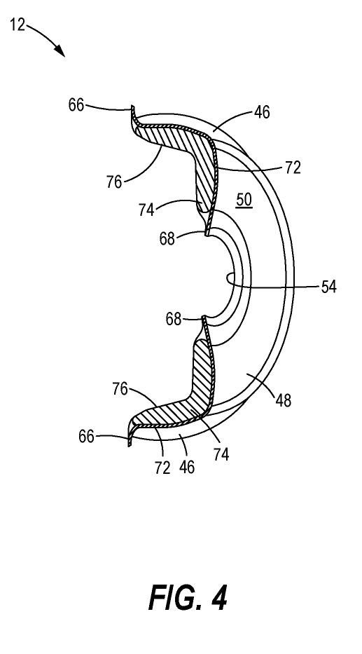

Turning to FIG. 4, a cross-sectional view of the heat shield 12 illustrates the multilayered construction of the heat shield 12. Specifically, the heat shield 12 includes an outer or first layer 72, an insulation material or second layer 74, and an inner or third layer 76. The material for the first and third layers 72, 76 may be a steel alloy such as stainless steel. More specifically, the first and third layer material may be a 300 series austenite steel or higher. For example, the first and third layers 72, 76 may be 304 grade (A2 stainless) or 316 grade (A4 stainless) steel, or a combination thereof. Further, the steel alloy of the first layer 72 may be different from the steel alloy of the third layer 76. The first and third layers 72, 76 of the disclosed heat shield may be stamped or machined stainless steel. Moreover, while not depicted, the outer surface 50 of the heat shield 12 or the first layer 72, as well as the inner surface 52 of the heat shield 12 or the third layer 76, may be textured. For example, such surfaces may be knurled, stamped, brushed or otherwise manipulated to create a texture thereon. In addition, the heat shield 12 may include other surface features know in the industry such as vanes, ribs, flanges, cutouts, ridges, etc. With regard to the thicknesses of the first and third layers 72, 76, the inner or third layer 76 is depicted as having a reduced thickness in comparison to the outer or first layer 72. Any number of various first and third layer thicknesses are contemplated and considered encompassed in this disclosure. For example, the third layer 76 may have a thickness of 0.076 mm while the first layer 72 may have a thickness of 0.4 mm. While this construction may offer advantages related to the efficiency and/or durability of the heat shield 12 and the turbocharger 10, such differences in thickness are not required, or may indeed be reversed. Additionally, certain embodiments may incorporate a minimized first and third layer thickness thereby reducing the thermal energy captured by these layers 72, 76.

FIG. 4 also illustrates the insulation material or second layer 74 of the heat shield 12, which is encapsulated by the first and third layers 72, 76. The material for the second layer 74 may be any insulation material. For example, the insulation material may be ceramic or a ceramic-containing material. Any number of various ceramic materials are contemplated herein and encompassed by this disclosure, including zirconia, nitride, alumina, oxide and carbide ceramics. Further, a combination of insulation materials or ceramics may be employed in the second layer 74 of the disclosed heat shield 12. For example, different insulation materials may be disposed in layers to make up the interior or second layer 74. Among other advantages, ceramics, being capable of withstanding temperatures ranging from 1,000° C. to 1,600° C., may withstand the high temperatures of the turbocharger environment. In addition, ceramics may have a thermal conductivity lower than that of metallic materials, and for the purpose of this disclosure, may be limited to around or below 0.25 W/m·K. Advantageously, such a low thermal conductivity limits the amount of heat that may be transferred into the bearing housing 20 from the turbine housing 24. In addition, any number of various insulation layer thicknesses are contemplated and considered encompassed in this disclosure. For example, the insulation material or second layer 74 may have a thickness up to and including 5 mm.

As further illustrated in FIG. 4, the insulation material or second layer 74 may form a significant portion of the closed end wall 48 and the sidewall 46 of the heat shield 12, while the first and third layers 72, 76 may merge together to encapsulate the second layer 74 and to also form the retaining tab 66 and the center edge 68. Any attachment means known in the industry may be employed to secure the first layer 72 to the third layer 76 and thereby encapsulate the insulation or second layer 74. For example, the first and third layers 72, 76 may be joined by soldering, welding, adhering, bonding, stamping or otherwise manipulating the stainless steel layers into a secure attachment. Additionally, while not shown in the drawings, contemplated herein are heat shields having additional layers. For example, such a heat shield may include additional stainless steel layers having a ceramic or insulation material encapsulated between each layer. This configuration may further the goal of reducing conduction of heat to the bearing housing, as well as lowering the heat shield temperature, thereby reducing conductive and radiative heat transfer to the bearing housing.

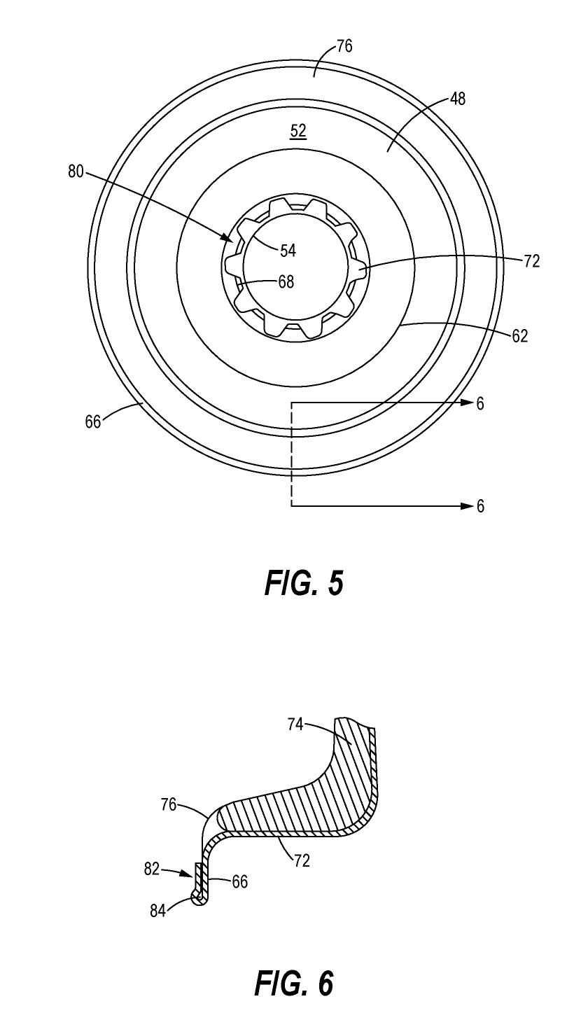

In an additional embodiment, as illustrated in FIGS. 5 and 6, the first and third layers 72, 76 may be crimped together. In such a configuration, the outer first layer 72 may fold around the center opening 54 and overlap the inner third layer 76 at the center edge 68 before compressing the layers together in an uninterrupted line or in a particular pattern or shape, as indicated at the arrow 80. Likewise, the outer first layer 72 may be folded around the inner third layer 76 at the retaining tab 66 edge before compressing the layers together, as indicated at the arrow 82. This crimping configuration may provide an air gap 84 where the first layer 72 overlaps the third layer 76 at both the retaining tab 66 edge, as well at the center edge 68, thereby creating a more tortuous path for conductive heat flow. Moreover, this crimping method of attachment may advantageously provide a joint area having multiple faces or edges at the center edge 68 and at the retaining tab 66, specifically in the areas indicated by the arrows 80, 82. This structure may further reduce the convection of heat towards the bearing housing. Alternatively, the overlap of the layers 72, 76 may be reversed. In another embodiment contemplated herein, rather than two distinct first and third layers 72, 76, the first and third layers may constitute one continuous layer around the insulation or second layer 74. In this manner, the two layers may merge seamlessly at the retaining tab 66 and at the center edge 68. In yet another embodiment, the layers 72, 76 may attach or merge adjacent the insulation or second layer 74 without the creation of a retaining tab 66 or a center edge 68. Finally, varying thicknesses of the first, second and third layers 72, 74, 76 may contribute to the dimensions and general shape of the heat shield 12. For example, the construction and configuration of these layers 72, 74, 76 may determine the contours of the heat shield 12, including any shoulder 60 and/or angled portion 62 elements.

### INDUSTRIAL APPLICABILITY

The disclosed turbocharger 10 can be integrated with the internal combustion engine of any number of vehicles to improve the performance of the vehicles and to enhancing fuel economy. In operation, the turbine wheel 34 of the turbocharger 10 is rotatably driven by an inflow of exhaust gas supplied from the exhaust manifold of an engine. Since the shaft 40 connects the turbine wheel 34 to the compressor wheel in the compressor housing, the rotation of the turbine wheel 34 causes rotation of the compressor wheel. As the compressor wheel rotates, it increases the air mass flow rate, airflow density and air pressure delivered to the engine's cylinders via an outflow from the compressor air outlet, which is connected to the engine's air intake manifold. As described above, the temperature within the turbocharger may reach or exceed 1,000° C. while operating. In addition to this high operating temperature that transfers heat into the bearing housing 20, significant heat soak may occur after the hot shut down of an engine, thereby continuing the conductive and radiative heat transfer to the bearing housing 20. While turbochargers provide several advantages, care must be taken to avoid the potential damage that may be incurred by the components of the turbocharger due to the very high heat environment. Such damage could not only decrease the efficiency of the turbocharger, but could also potentially result in the release of oil into the turbine housing and into the environment.

The disclosed heat shield 12, designed to be disposed in the turbocharger 10 between the bearing housing 20 and the turbine wheel 34 of the turbocharger 10, can significantly reduce the heat transferred from the turbine side of the turbocharger to the bearing side, thereby protecting many of the components of the turbocharger 10. Among other things, the disclosed heat shield 12 may protect piston ring-type seal rings oftentimes disposed on the shaft 40, which help to maintain an oil separation between the bearing 20 housing and the turbine housing 24. Importantly, damage to or breakdown of these rings due to high heat is detrimental to both the functioning of the turbocharger and to the environment. In addition, by reducing the heat transferred into the bearing housing 20, the disclosed heat shield 12 protects the lubricating oil in the bearing housing 20 from excessive heat, thereby avoiding the potentially damaging burned oil deposits oftentimes found on the bearings and bearing housing surfaces of conventional turbochargers with conventional heat shields. Moreover, with a significant enough heat reduction, the use of water-cooled bearing housings may not be required.

In comparison to conventional, single layer stamped heat shields, the disclosed multilayered encapsulated heat shield 12 having an insulation material 74 encapsulated by the inner and outer layers 72, 76 may have a reduced heat shield temperature thereby reducing conductive, convective and radiative heat transfer into the bearing housing 20. This reduction in heat transfer may be during turbocharger operation, or after the hot shut down of the engine, as may be appreciated from a thermal survey of the turbocharger 10 after a hot shut down (during a heat soak period). For example, the disclosed heat shield 12 may improve heat soak at numerous locations within the bearing housing 20, including an 11% improvement at piston rings, as well as improvements at bearing supports, i.e., a 6% improvement at a turbine cradle and a 9% improvement at a compressor cradle. The shape, the multiple faces/edges, the air gap component, the material make up and the layered configuration of the disclosed heat shield 12 may contribute to this reduction of heat transferred into the bearing housing 20 from the turbine side of the turbocharger 10. The disclosed heat shield 12 therefore further adds to the already improved efficiency and durability of turbochargers employing conventional heat shields. Moreover, because the disclosed heat shield 12 further protects the components of the turbocharger 10 from damage and breakdown, the potential for release of lubricating oil into the environment may also be lowered. Finally, the disclosed heat shield 12 may be retrofitted to existing turbochargers, i.e., it can take the place of an existing heat shield without requiring any turbocharger modifications. The disclose heat shield 12 may therefore provide a cost-effective fix for a turbocharger having a damaged or less efficient heat shield, or may be provided as a replacement part in a remanufactured turbocharger, for example.

All references to the disclosure or examples thereof are intended to reference the particular example being discussed at that point and are not intended to imply any limitation as to the scope of the disclosure more generally. Also, it will be apparent to those skilled in the art that various modifications and variations can be made to the stabilizer pads of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A heat shield (12) configured to be disposed between a bearing housing (20) and a turbine wheel (34) of a turbocharger (10), the heat shield (12) comprising:
a closed end wall (48) and a sidewall (46) extending from the closed end wall (48);
a center opening (54) in the closed end wall (48), the center opening (54) configured to receive a shaft (40) of the turbocharger (10);
an outer layer (72) of the heat shield (12) and an inner layer (76) of the heat shield (12); and
an insulation material (74) disposed between the outer layer (72) and the inner layer (76) of the heat shield (12), the outer layer (72) and the inner layer (76) encapsulating the insulation material (74).

2. The heat shield (12) of claim 1, wherein the insulation material (74) comprises ceramic.

3. The heat shield (12) of claim 1, wherein the outer layer (72) and the inner layer (76) comprise stainless steel.

4. The heat shield (12) of claim 1, further comprising:
a retaining tab (66) extending from the sidewall (46) opposite the closed end wall (48), the retaining tab (66) configured to be fixed between the bearing housing (20) and a turbine housing (24) of the turbocharger (10); and
a center edge (68) that defines the center opening (54).

5. The heat shield (12) of claim 4, wherein the outer layer (72) and the inner layer (76) of the heat shield (12) are attached at the retaining tab (66) and at the center edge (68), the insulation material (74) being encapsulated therebetween.

6. The heat shield (12) of claim 5, wherein the outer layer (72) and the inner layer (76) are attached by crimping overlapping areas of the outer layer (72) and the inner layer (76).

7. The heat shield (12) of claim 6, wherein the attachment of the outer layer (72) and the inner layer (76) creates multiple edges (80, 82) and an air gap (84) in the heat shield (12).

8. The heat shield (12) of claim 1, wherein the inner layer (76) has a reduced thickness compared to the outer layer (72).

9. A turbocharger (10) comprising:
a bearing housing (20);
a shaft (40) mounted for rotation in the bearing housing (20);
a turbine wheel (34) attached to one end of the shaft (40) and configured to be driven by exhaust gas flow; and
a heat shield (12) disposed between the bearing housing (20) and the turbine wheel (34), the heat shield (12) comprising:
a closed end wall (48) and a sidewall (46) extending from the closed end wall (48);
a center opening (54) in the closed end wall (48), the center opening (54) configured to receive the shaft (40) of the turbocharger (10);
an outer layer (72) of the heat shield (12) and an inner layer (76) of the heat shield (12); and
an insulation material (74) disposed between the outer layer (72) and the inner layer (76) of the heat shield (12), the outer layer (72) and the inner layer (76) encapsulating the insulation material (74).

10. The turbocharger (10) of claim 9, wherein the insulation material (74) comprises ceramic.

11. The turbocharger (10) of claim 9, wherein the outer layer (72) and the inner layer (76) comprise stainless steel.

12. The turbocharger (10) of claim 9, further comprising:
a retaining tab (66) extending from the sidewall (46) opposite the closed end wall (48), the retaining tab (66) configured to be fixed between the bearing housing (20) and a turbine housing (24) of the turbocharger (10); and
a center edge (68) that defines the center opening (54).

13. The turbocharger (10) of claim 12, wherein the outer layer (72) and the inner layer (76) of the heat shield (12) are attached at the retaining tab (66) and at the center edge (68), the insulation material (74) being encapsulated therebetween.

14. The turbocharger (10) of claim 13, wherein the outer layer (72) and the inner layer (76) are attached by crimping overlapping areas of the outer layer (72) and the inner layer (76).

15. The turbocharger (10) of claim 14, wherein the attachment of the outer layer (72) and the inner layer (76) creates multiple edges (80, 82) and an air gap (84) in the heat shield (12).

16. The turbocharger (10) of claim 9, wherein the inner layer (76) has a reduced thickness compared to the outer layer (72).

17. A turbocharger (10) comprising:
a turbocharger housing including a compressor housing, a bearing housing (20), and a turbine housing (24);
a turbine wheel (34) located in the turbine housing (24);
a compressor wheel located in the compressor housing;
a shaft (40) extending through the bearing housing (20) and connecting the turbine wheel (34) and the compressor wheel; and
a multilayered heat shield (12) disposed between the turbine wheel (34) and the bearing housing (20), the multilayered heat shield (12) comprising:
a first layer (72) comprising stainless steel;
a second layer (74) comprising an insulation material; and
a third layer (76) comprising stainless steel, the first and the third layers (72, 76) being attached to encapsulate the second layer (74).

18. The turbocharger (10) of claim 17, wherein the second layer (74) is ceramic.

19. The turbocharger (10) of claim 17, further comprising a retaining tab (66) where the first layer (72) is attached to the third layer (76), the retaining tab (66) configured to be fixed between the bearing housing (20) and the turbine housing (24).

20. The turbocharger (10) of claim 19, wherein the attachment of the first layer (72) and the third layer (76) at the retaining tab (66) comprises an overlap of the first layer (72) over the third layer (76).
